(19) United States
(12) Patent Application Publication
(10) Pub. No.: US 2015/0345544 A1
(43) Pub. Date: Dec. 3, 2015

(54) SYSTEM AND METHOD OF INSERTION FOR SHIM

(71) Applicant: Caterpillar Inc., Peoria, IL (US)

(72) Inventor: Vellore S. Senthilkumar, Chennai (IN)

(73) Assignee: Caterpillar Inc., Peoria, IL (US)

(21) Appl. No.: 14/826,286

(22) Filed: Aug. 14, 2015

(51) Int. Cl. F16C 11/04; B25B 27/14

(52) U.S. Cl. CPC F16C 11/04; B25B 27/14

(57) ABSTRACT

A method of insertion for a shim associated with a linkage assembly of a machine is provided. The method includes positioning a boom of the linkage assembly on a platform assembly. The method also includes lowering a stick of the linkage assembly onto the platform assembly. The method further includes sliding a shim into a gap created between respective first and second mounting surfaces. The method includes positioning a shim locator tool with respect to the stick and the boom. The method also includes rotating the shim locator tool about a central axis by exerting a torque on a handle portion of the shim locator tool.

### TECHNICAL FIELD

The present disclosure relates to a system and method of insertion for a shim, and more particularly to the system and method of insertion for a shim associated with a linkage assembly of a machine.

### BACKGROUND

In machines such as a backhoe loader, shims are used in various locations to align two adjacent components as part of an assembly procedure. For example, in a boom and stick assembly, after the shims are inserted for co-planar alignment between the adjacent components, a pin is driven through them which also pass through the shim. The shim insertion process currently being used is a manual process. In order to drive the pin, the shim has to be aligned with the adjacent components. For having the shim aligned with the adjacent components, operators generally use their finger to ensure the shim is in place, and then drive the pin through it.

Further, in most cases for driving the pin through the adjacent components, one of the components is generally suspended from a crane. Whereas the second component is provided on a fixture. The suspension of the component from the crane makes the shim insertion process difficult, as the operator may misjudge how to locate the shim.

U.S. Pat. No. 8,590,133, hereinafter referred as the '133 patent, describes a tool for placing a shim between a housing and a component biased towards the housing is provided. The tool can include a handle and a pair of spaced-apart tongs extending outwardly from the handle. In addition, a shim support surface can be located between the pair of spaced-apart tongs. The spaced-apart tongs and the shim support surface can be dimensioned for a shim to nest between the tongs on the shim support surface. However, the tool described in the '133 patent includes spring biasing components that may make the tool complex in design and use.

### SUMMARY OF THE DISCLOSURE

In one aspect of the present disclosure, a method of insertion for a shim associated with a linkage assembly of a machine is provided. The method includes positioning a boom of the linkage assembly on a platform assembly. The boom includes a first mounting surface and a first mounting bore extending from the first mounting surface, the first mounting bore defining a central axis. The method also includes lowering a stick of the linkage assembly onto the platform assembly. The stick includes a second mounting surface and a second mounting bore extending from the second mounting surface. The lowering of the stick is configured to align the second mounting bore of the stick with respect to the first mounting bore of the boom and wherein a gap is created between the respective first and second mounting surfaces of the boom and the stick. The method further includes sliding the shim into the gap created between the respective first and second mounting surfaces. The method includes positioning a shim locator tool with respect to the stick and the boom. A pin piloting section of the shim locator tool is inserted into the second mounting bore. The pin piloting section includes a diameter sized approximately equal to a diameter of the second mounting bore and an inner diameter of the shim. Further, a projection extending perpendicularly from an outer periphery of the pin piloting section is in a contacting relationship with a portion of the inner circumference of the shim. The method also includes rotating the shim locator tool about the central axis by exerting a torque on a handle portion of the shim locator tool. The pin piloting section is sequentially piloted within the second mounting bore and the inner diameter of the shim based on the rotation. The shim is contemporaneously aligned and inserted within the gap between the boom and the stick based on the rotation of the shim locator tool.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a perspective view of a boom positioned on a platform assembly and a stick of the machine of FIG. 1, according to one embodiment of the present disclosure;

FIG. 3 is a perspective view of a shim locator tool, according to one embodiment of the present disclosure;

FIGS. 4 to 9 are side views showing various steps followed during an insertion process of a shim using the shim locator tool of FIG. 3, according to one embodiment of the present disclosure;

FIG. 10 is front view of an assembly of the boom and stick after the insertion of the shim; and

FIG. 11 is a flowchart for a method of insertion for the shim associated with a linkage assembly of the machine.

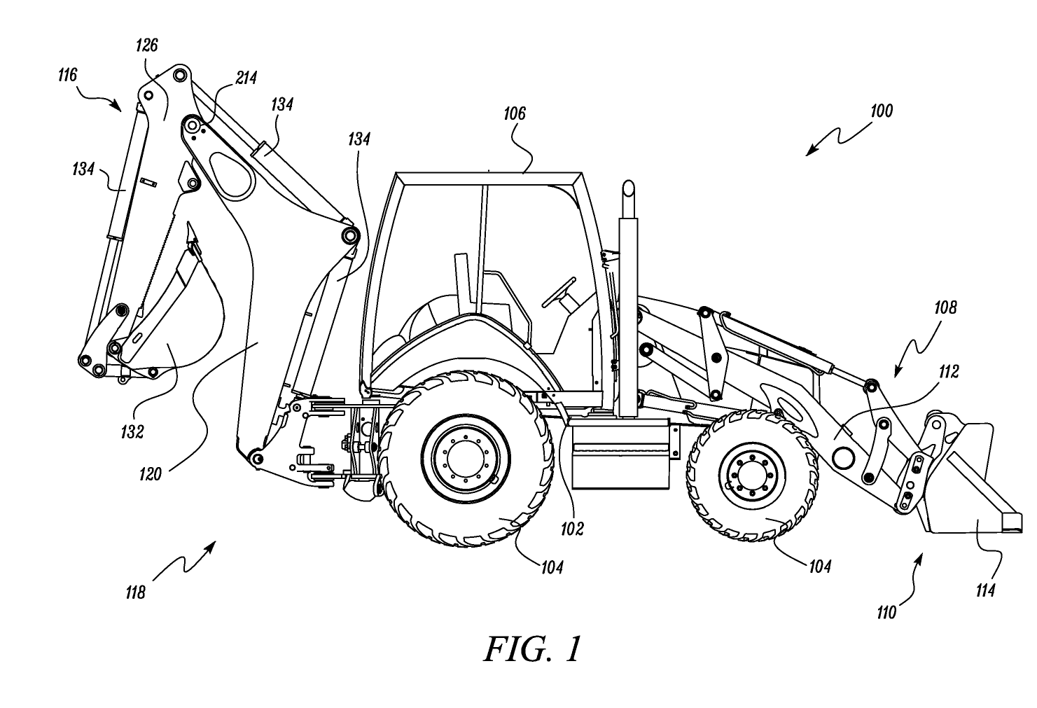

### DETAILED DESCRIPTION

Wherever possible, the same reference numbers will be used throughout the drawings to refer to the same or the like parts. Referring to FIG. 1, an exemplary machine 100 is illustrated. More specifically, the machine 100 is a backhoe loader. Alternatively, the machine 100 may be any machine including, but not limited to, a wheel loader, an excavator, a shovel, a dozer, a mining truck, an articulated truck, a track type tractor, a forklift, and a crane. The machine 100 may be any machine known in the art associated with industries including, but not limited to, agriculture, transportation, mining, construction, forestry, and material handling.

The machine 100 includes a frame 102. A power source (not shown) is provided on the frame 102 of the machine 100. The power source may be any power source known in the art, such as, an internal combustion engine, an electric motor, power storage device like batteries, and a hybrid engine. The power source is configured to provide power to the machine 100 for operational and mobility requirements. The machine 100 includes a set of ground engaging members 104, herein embodied as wheels. The ground engaging members 104 are configured to provide mobility to the machine 100. The machine 100 also includes a drivetrain (not shown) coupled to the power source and the ground engaging members 104. The drivetrain may include a transmission system having one or more gears, shafts, differentials, torque convertor, hydraulic pump or motor, and so on. The drivetrain may be configured to transmit motive power from the power source to the ground engaging members 104.

The machine 100 also includes an operator cabin 106 provided on the frame 102 of the machine 100. The operator cabin 106 includes an operator interface (not shown). The operator interface may include one or more input devices such as pedals, steering, joystick, knobs, levers, switches, display devices and so on. The input device may be configured to operate the machine 100.

The machine 100 includes one or more attachment elements and associated components pivotally coupled to the frame 102. In the illustrated embodiment, a linkage assembly 108 is provided at a front portion 110 of the machine 100. The linkage assembly 108 includes a linkage member 112. The linkage member 112 is pivotally coupled to the frame 102. An attachment element 114 is pivotally coupled to the linkage member 112. The attachment element 114 is configured to collect, hold, and convey material and/or heavy objects on the ground. The attachment element 114 may embody a worktool, implement, and the like.

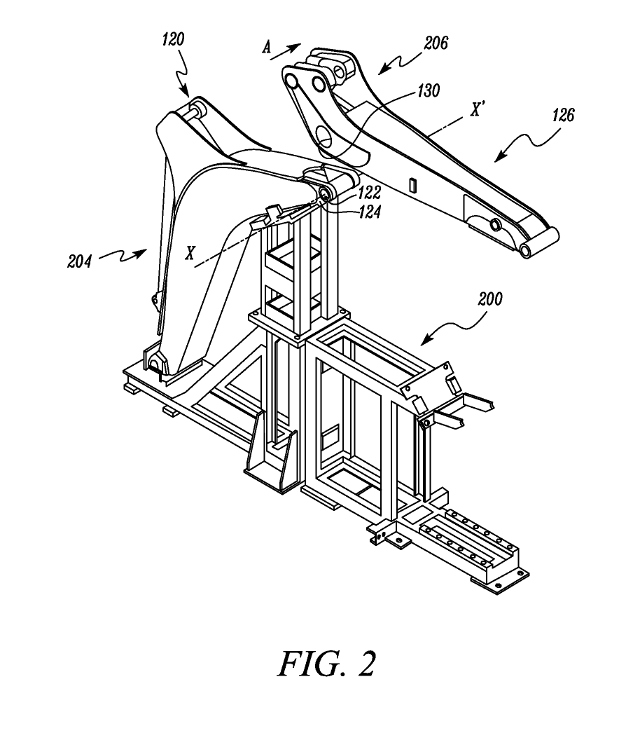

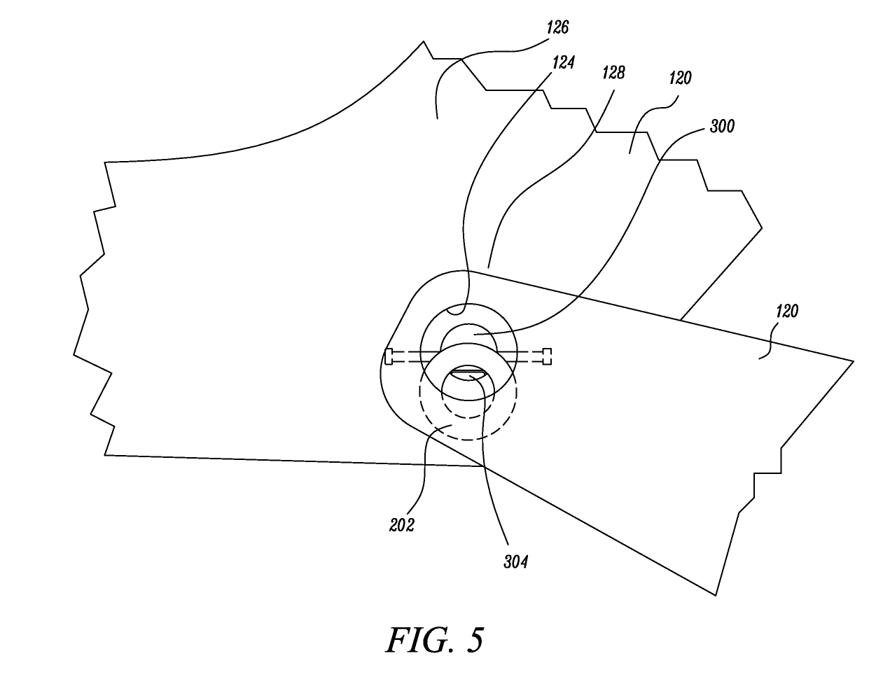

A linkage assembly 116 is provided at a rear portion 118 of the machine 100. Referring to FIG. 2, the linkage assembly 116 includes a boom 120 pivotally coupled to the frame 102. The boom 120 includes a first mounting surface 122. The boom 120 also includes a first mounting bore 124. The first mounting bore 124 extends from the first mounting surface 122. The first mounting bore 124 defines a central axis X-X′. The linkage assembly 116 includes a stick 126 pivotally coupled to the boom 120 (see FIG. 1). The stick 126 includes a second mounting surface 128 (see FIG. 5). The stick 126 also includes a second mounting bore 130. The second mounting bore 130 extends from the second mounting surface 128.

As shown in FIG. 1, an attachment element 132 is pivotally affixed to the stick 126. The linkage assembly 116 includes hydraulic and/or pneumatic cylinders 134 for providing required spatial movement to the boom 120, the stick 126, and the attachment element 132.

It should be noted that the attachment elements 114, 132 may include any one of a bucket, an auger, a blade, a fork, a hammer, a ripper, or any other known work implement. The linkage assemblies 108, 116 are configured to perform tasks such as, earth moving, excavation, digging, demolition, and the like. Further, the linkage assemblies 108, 116 may be controlled electrically, mechanically, hydraulically, pneumatically, or by a combination thereof.

Referring to FIG. 2, during assembly of the boom 120 and the stick 126 of the linkage assembly 116, the boom 120 is positioned on a platform assembly 200. Once the boom 120 is positioned on the platform assembly 200, the stick 126 is lowered onto the platform assembly 200. The stick 126 is lowered such that the second mounting bore 130 of the stick 126 is aligned with the first mounting bore 124 of the boom 120. The stick 126 is generally lowered by a crane (not shown) or any other mechanical element that allows the lowering of the stick 126.

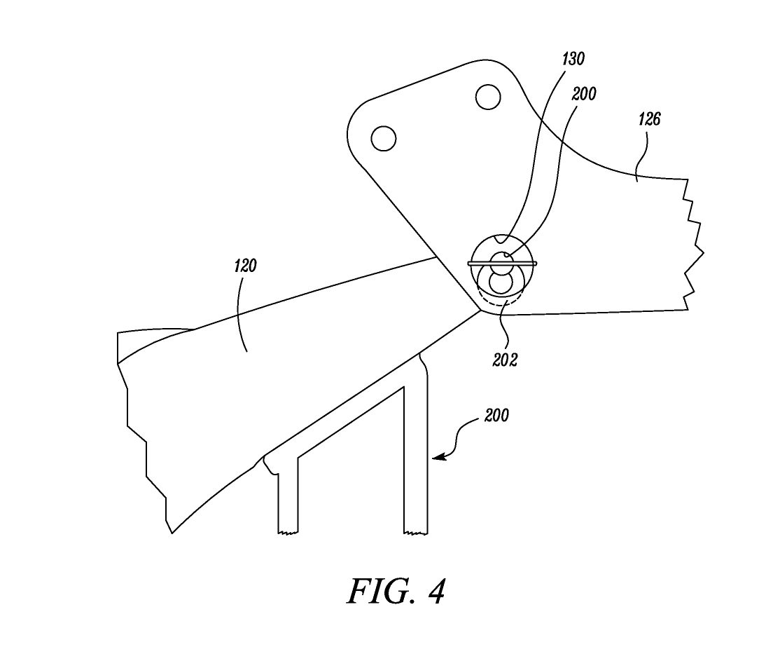

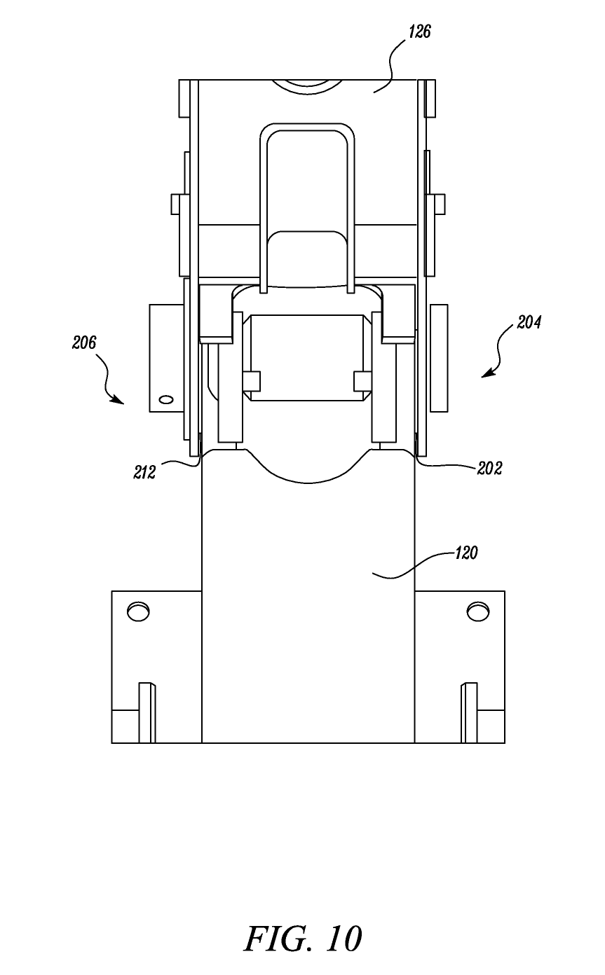

Due to design and tolerances of the boom 120 and the stick 126, a gap generally exists between the respective first and second mounting surfaces 122, 128 of the boom 120 and the stick 126, after the lowering of the stick 126. In order to bridge the gap between the first and second mounting surfaces 122, 128, a shim 202 (see FIG. 4) is contemporaneously aligned and inserted within the gap between the surfaces of the boom 120 and the stick 126 at a first side 204 of the assembly. Further, a shim 212 (see FIG. 10) may be contemporaneously aligned and inserted within a gap between surfaces of the boom 120 and the stick 126 at a second side 206 of the assembly. Accordingly, the present disclosure is related to a shim locator tool 300 that is used to position the shim 202, 212 between the boom 120 and the stick 126.

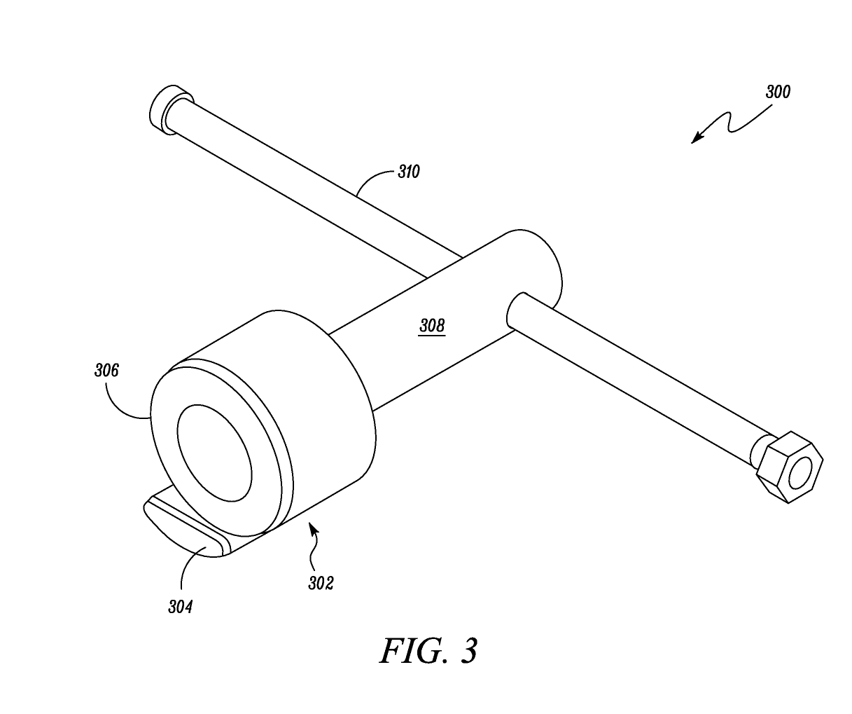

For exemplary purposes, the shim locator tool 300 and an insertion process of the shim 202 provided at the first side 204 will be described in detail herein with respect to FIGS. 3-10. However, it should be noted that the description provided is equally applicable to the shim 212 (see FIG. 10) that is provided at the second side 206 of the assembly.

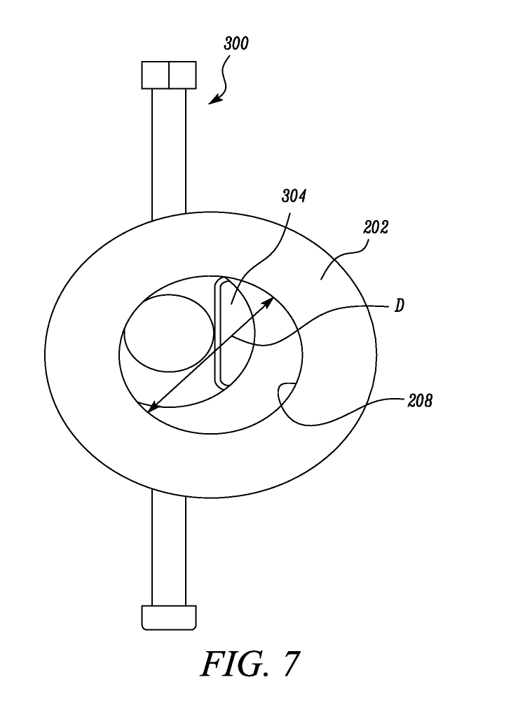

Referring to FIG. 3, the shim locator tool 300 includes a pin piloting section 302. The pin piloting section 302 is cylindrical in shape. The pin piloting section 302 has a diameter sized approximately equal to a diameter of the first mounting bore 124, a diameter of the second mounting bore 130, and an inner diameter “D” (see FIG. 7) of the shim 202. The pin piloting section 302 includes a projection 304. The projection 304 extends perpendicularly from an outer periphery 306 of the pin piloting section 302.

The shim locator tool 300 includes a circular bar member 308. One end of the bar member 308 is fixedly attached to the pin piloting section 302. Whereas another end of the bar member 308 includes a handle portion 310. The handle portion 310 is provided perpendicular to the bar member 308. A length of the handle portion 310 is comparatively greater than a combined length of the pin piloting section 302 and the bar member 308. During the insertion of the shim 202, the handle portion 310 provides a gripping surface to an operator to hold on to. The shim locator tool 300 may be made of any metal or non-metal known in the art.

For inserting the shim 202 in the gap created between the boom 120 and the stick 126, the shim 202 is manually inserted between the respective first and second mounting surfaces 122, 128. Referring to FIG. 4, the shim locator tool 300 is positioned with respect to the stick 126 and the boom 120. The shim locator tool 300 may be positioned such that the pin piloting section 302 of the shim locator tool 300 is inserted into the second mounting bore 130 of the stick 126 in a first direction “A” (see FIG. 2). In an alternate example, the shim locator tool 300 may be positioned such that the pin piloting section 302 of the shim locator tool 300 is inserted into the first mounting bore 124 of the boom 120 in a direction that is opposite to the first direction “A”.

Referring to FIGS. 4 and 5, as the pin piloting section 302 is introduced into the second mounting bore 130, the projection 304 of the pin piloting section 302 is in a contacting relationship with a portion of an inner circumference 208 (see FIG. 7) of the shim 202. Once the shim locator tool 300 is in contact with the shim 202, the shim locator tool 300 is rotated by the operator about the central axis X-X′. The shim locator tool 300 is rotated by exerting a torque on the handle portion 310 of the shim locator tool 300. The shim locator tool 300 may be rotated in a clockwise direction or an anti-clockwise direction with respect to the central axis X-X′. In the accompanying figures, the shim locator tool 300 is rotated in the clockwise direction about the central axis X-X′.

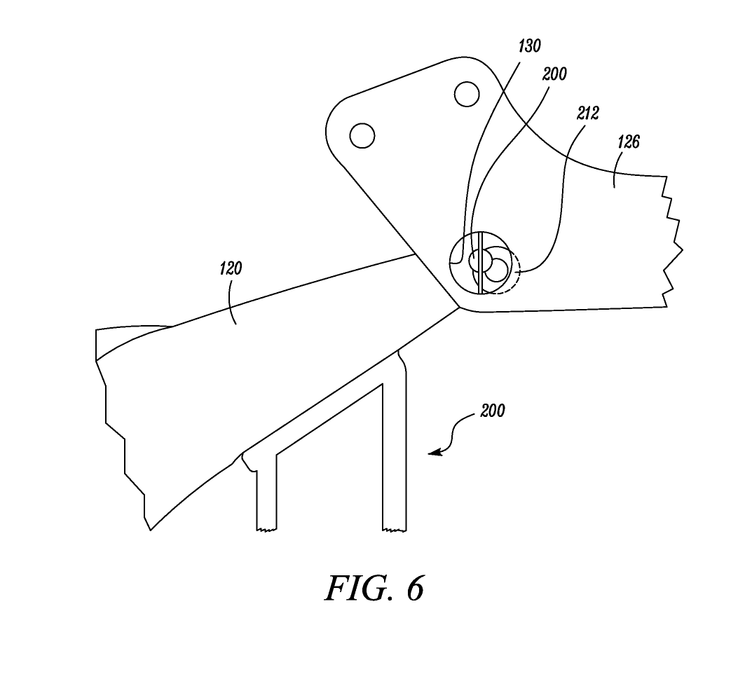

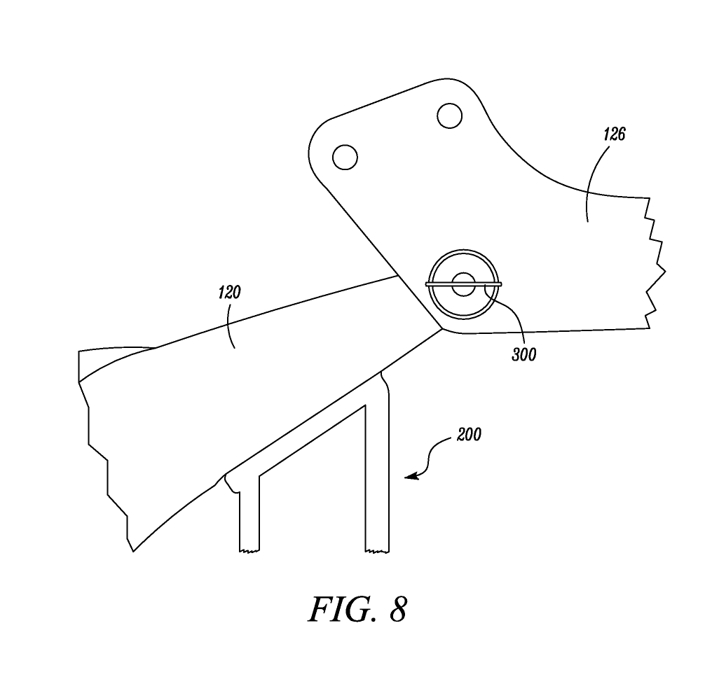

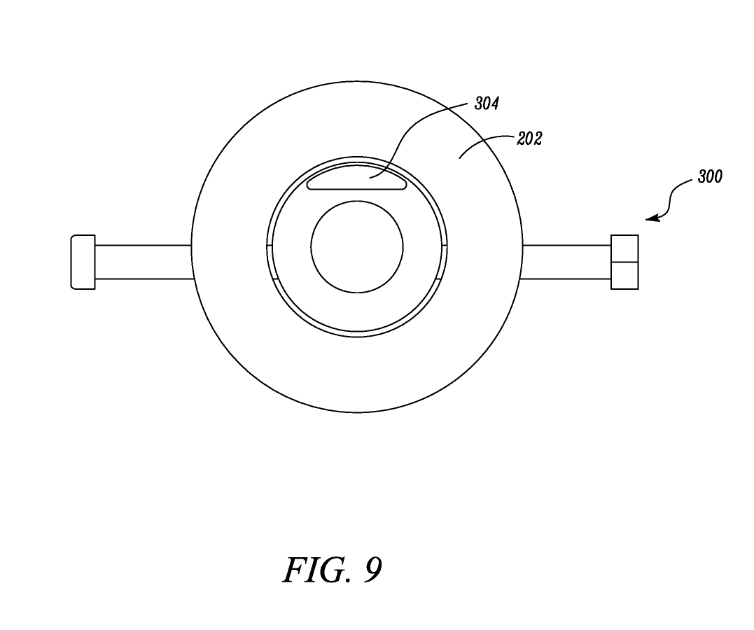

As shown in FIGS. 6 and 7, as the shim locator tool 300 is rotated, at least some portion of the projection 304 of the pin piloting section 302 is in contact with the inner circumference 208 of the shim 202. As the shim locator tool 300 is rotated, the shim 202 is pulled up and placed between the boom 120 and the stick 126. Referring now to FIGS. 8 and 9, on continuous rotation of the shim locator tool 300, the pin piloting section 302 is sequentially piloted within the second mounting bore 130 and the inner diameter “D” of the shim 202.

As shown in FIGS. 8, 9, and 10, once the shim locator tool 300 is rotated by 180°, the shim 202 is contemporaneously aligned and inserted within the gap between the boom 120 and the stick 126 based on the rotation of the shim locator tool 300. Once the shim 202 is positioned correctly, the shim locator tool 300 is further driven such that the pin piloting section 302 is inserted into the first mounting bore 124 of the boom 120 in order to ensure that the first mounting bore 124 is in alignment with the inner diameter “D” (see FIG. 7) of the shim 202 and the second mounting bore 130. After inserting the shim 202, the shim locator tool 300 is removed from the first mounting bore 124, the inner diameter “D” of the shim 202, and the second mounting bore 130. The thickness of the shim 202 is decided such that the shim 202 does not slide out from the gap after the removal of the shim locator tool 300.

Further, after removal of the shim locator tool 300, each of the second mounting bore 130 of the stick 126, the inner diameter “D” of the shim 202, and the first mounting bore 124 of the boom 120 are aligned to receive a mechanical fastener 210 (see FIG. 1). The mechanical fastener 210 is configured to couple the stick 126 with the boom 120 at the first side 204. Further, the operator may insert the shim 212 at the second side 206 after which a mechanical fastener (not shown) is driven through the bore of the stick 126, an inner diameter of the shim 212, and the bore of the boom 120 to couple the stick 126 with the boom 120.

### INDUSTRIAL APPLICABILITY

The present disclosure relates to the shim locator tool 300 that is used for insertion of the shim 202, 212 between the boom 120 and the stick 126. The projection 304 at the pin piloting section 302 of the shim locator tool 300 allows the shim 202, 212 to be easily pulled up to position it at the required location. Further, the handle portion 310 of the shim locator tool 300 allows for easy rotation of the shim locator tool 300 without causing any operator fatigue. The shim locator tool 300 disclosed herein includes fewer parts and is easy to manufacture. Also, the shim locator tool 300 is simple in use and is cost effective. Further, the shim locator tool 300 eliminates usage of the finger of the operator for insertion of the shim 202, 212, thereby improving operator safety. The insertion process using the shim locator tool 300 is reliable and less prone to errors.

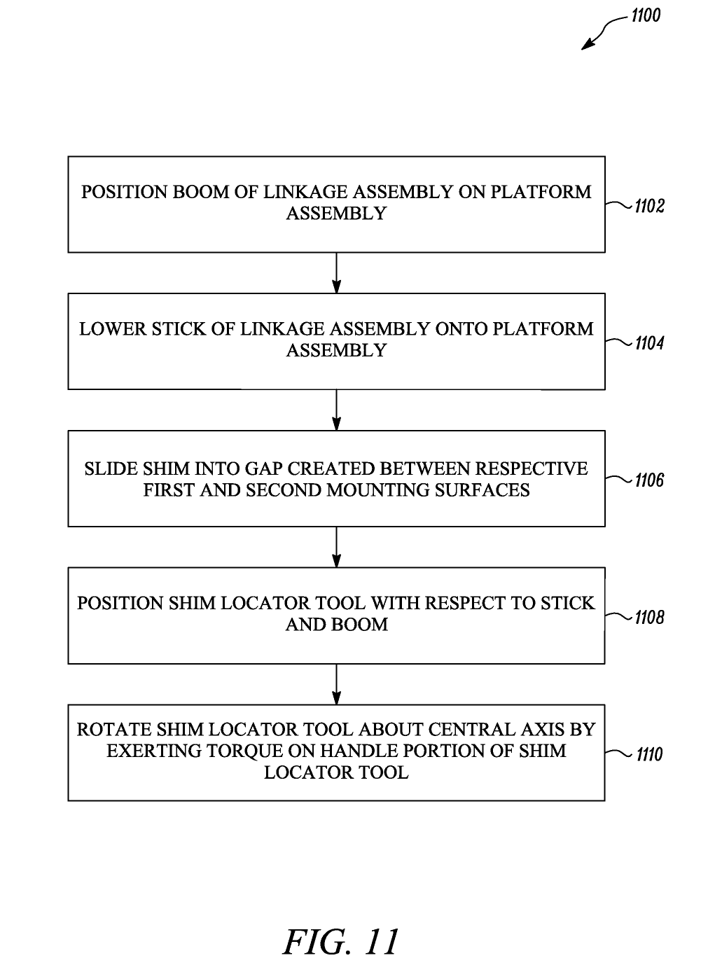

FIG. 11 is a flowchart for a method 1100 of insertion for the shim 202 associated with the linkage assembly 116 of the machine 100. The method will be explained in relation to the shim 202 provided at the first side 204. At step 1102, the boom 120 of the linkage assembly 116 is positioned on the platform assembly 200. The boom 120 includes the first mounting surface 122 and the first mounting bore 124 extending from the first mounting surface 122. The first mounting bore 124 defines the central axis X-X′.

At step 1104, the stick 126 of the linkage assembly 116 is lowered onto the platform assembly 200. The stick 126 includes the second mounting surface 128 and the second mounting bore 130 extending from the second mounting surface 128. The lowering of the stick 126 is configured to align the second mounting bore 130 of the stick 126 with respect to the first mounting bore 124 of the boom 120. Further, on lowering the stick 126, the gap is created between the respective first and second mounting surfaces 122, 128 of the boom 120 and the stick 126.

At step 1106, the shim 202 is slid into the gap created between the respective first and second mounting surfaces 122, 128. At step 1108, the shim locator tool 300 is positioned with respect to the stick 126 and the boom 120. Also, the pin piloting section 302 of the shim locator tool 300 is inserted into the second mounting bore 130. The diameter of the pin piloting section 302 is sized approximately equal to the diameter of the second mounting bore 130 and the inner diameter “D” of the shim 202. Further, the projection 304 extending perpendicularly from the outer periphery 306 of the pin piloting section 302 is in the contacting relationship with the portion of the inner circumference 208 of the shim 202.

At step 1110, the shim locator tool 300 is rotated about the central axis X-X′ by exerting the torque on the handle portion 310 of the shim locator tool 300. Also, on rotation, the pin piloting section 302 is sequentially piloted within the second mounting bore 130 and the inner diameter “D” of the shim 202. Further, based on the rotation of the shim locator tool 300, the shim 202 is contemporaneously aligned and inserted within the gap between the boom 120 and the stick 126.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of insertion for a shim associated with a linkage assembly of a machine, the method comprising:
positioning a boom of the linkage assembly on a platform assembly, the boom having a first mounting surface and a first mounting bore extending from the first mounting surface, the first mounting bore defining a central axis;
lowering a stick of the linkage assembly onto the platform assembly, the stick having a second mounting surface and a second mounting bore extending from the second mounting surface, wherein the lowering of the stick is configured to align the second mounting bore of the stick with respect to the first mounting bore of the boom and wherein a gap is created between the respective first and second mounting surfaces of the boom and the stick;
sliding the shim into the gap created between the respective first and second mounting surfaces;
positioning a shim locator tool with respect to the stick and the boom, wherein a pin piloting section of the shim locator tool is inserted into the second mounting bore, the pin piloting section having a diameter sized approximately equal to a diameter of the second mounting bore and an inner diameter of the shim, and wherein a projection extending perpendicularly from an outer periphery of the pin piloting section contacts with an inner circumference of the shim; and
rotating the shim locator tool about the central axis by exerting a torque on a handle portion of the shim locator tool, wherein the pin piloting section is sequentially piloted within the second mounting bore and the inner diameter of the shim based on the rotation,
wherein the shim is contemporaneously aligned and inserted within the gap between the boom and the stick based on the rotation of the shim locator tool.
